(19) United States
(12) Patent Application Publication
(10) Pub. No.: US 2026/0253273 A1
(43) Pub. Date: Aug. 27, 2026

(54) GRAPH CREATION

(71) Applicant: Lemon Inc., Grand Cayman (KY)

(72) Inventors: Clarence WANG, Culver City, CA (US); Runze ZHANG, Los Angeles, CA (US)

(21) Appl. No.: 19/063,264

(22) Filed: Feb. 25, 2025

(51) Int. Cl. G06T 11/20

(52) U.S. Cl. CPC G06T 11/26; G06T 2200/24

(57) ABSTRACT

Described herein are techniques for creating graphs. A type of connection node applicable to the graphs is created in response to receiving user input. The type of connection node is configured to transmit data and not to process data. The type of connection node is configured to switch positions of input and output ports. At least one connection node of the type is added into a graph. The graph comprises a plurality of data nodes configured to process data. The graph comprises a plurality of edges connecting the plurality of data nodes. Adjustments to the graph are implemented by utilizing the at least one connection node.

### BACKGROUND

The increasing use of visual programming has led to the frequent generation of large, complex graphs. However, it can be difficult to read the logic of such complex graphs, thereby leading to a poor user experience.

### BRIEF DESCRIPTION OF THE DRAWINGS

The following detailed description can be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system that may be utilized in the present disclosure.

FIG. 2 shows an example graph.

FIG. 3 shows an example connection node in accordance with the present disclosure.

FIG. 4 shows an example expanded state of a connection node in accordance with the present disclosure.

FIG. 5A shows an example graph with crossing edges connecting a plurality of nodes.

FIG. 5B shows an example graph with smooth edges connecting a plurality of nodes in accordance with the present disclosure.

FIG. 6 shows an example group of connection nodes in a first mode in accordance with the present disclosure.

FIG. 7 shows an example group of connection nodes in a first mode in accordance with the present disclosure.

FIG. 8 shows an example group of connection nodes in a second mode in accordance with the present disclosure.

FIG. 9 shows an example process for creating graphs in accordance with the present disclosure.

FIG. 10 shows an example process for creating graphs in accordance with the present disclosure.

FIG. 11 shows an example process for creating graphs in accordance with the present disclosure.

FIG. 12 shows an example process for creating graphs in accordance with the present disclosure.

FIG. 13 shows an example process for creating graphs in accordance with the present disclosure.

FIG. 14 shows an example process for creating graphs in accordance with the present disclosure.

FIG. 15 shows an example process for creating graphs in accordance with the present disclosure.

FIG. 16 shows an example process for creating graphs in accordance with the present disclosure.

FIG. 17 shows an example computing device which can be used to perform any of the techniques disclosed herein.

### DETAILED DESCRIPTION OF ILLUSTRATIVE EMBODIMENTS

Visual scripting (e.g., visual programming) can enable a user to create scripting logic with visual, drag-and-drop graphs instead of requiring the user to write code from scratch. The increased use of visual scripting has therefore led to the frequent generation of large, complex graphs. However, it can be difficult to read the logic of such complex graphs, thereby leading to a poor user experience. Thus, effective techniques for improving the presentation and readability of large, complex graphs are needed. Described herein are techniques for improving the presentation and readability of large, complex graphs that can include many data nodes. The techniques described herein utilize a new type of connection node that can facilitate the easy readability of complex node connection routes including end-to-end connections and cross-connections.

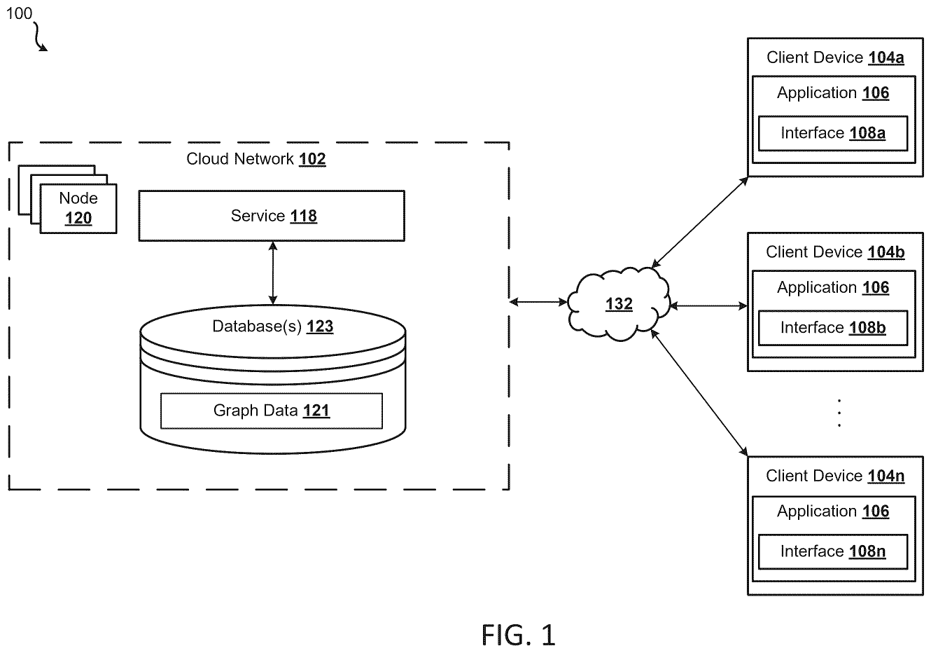

FIG. 1 shows an example system 100 that may be utilized in the present disclosure. The system 100 can include a cloud network 102 and a plurality of client devices 104a-n (collectively, 104). The cloud network 102 and the client devices 104 can communicate with each other via one or more networks 132.

The cloud network 102 can be located at a data center, such as a single premise, or be distributed throughout different geographic locations (e.g., at several premises). The cloud network 102 can provide services, such as a content creation service 118, via the one or more networks 132. The network 132 comprise a variety of network devices, such as routers, switches, multiplexers, hubs, modems, bridges, repeaters, firewalls, proxy devices, and/or the like. The network 132 can comprise physical links, such as coaxial cable links, twisted pair cable links, fiber optic links, a combination thereof, and/or the like. The network 132 can comprise wireless links, such as cellular links, satellite links, Wi-Fi links and/or the like.

The cloud network 102 can host a variety of services. In an embodiment, the cloud network 102 hosts the service 118 among other services. The service 118 can be configured to facilitate visual programming, material editing, and/or particle editing using graphs. For example, the service 118 can be configured to facilitate visual scripting by a user (e.g., developer) to enable the user to create or design content, such as effects and/or games, using graphs. The user can be associated with a client device of the plurality of client devices 104a-n. For example, the plurality of client devices 104a-n can each be associated with a user that wants to perform visual scripting. The plurality of client devices 104a-n can comprise an application 106. The application 106 can be used by the users to perform visual scripting using graphs. For example, the users can access interface(s) 108a-n (collectively, 108) of the application 106 to perform visual scripting for creating or editing content. The application 106 can be associated with the service 118.

The plurality of client devices 104a-n can comprise any type of computing device, such as a mobile device, a tablet device, laptop, a desktop computer, a smart television or other smart device (e.g., smart watch, smart speaker, smart glasses, smart helmet), a gaming device, a set top box, digital streaming device, robot, and/or the like. A single user can use one or more of the plurality of client devices 104a-n to access the cloud network 102. The plurality of client devices 104a-n can travel to a variety of locations and use different networks to access the cloud network 102.

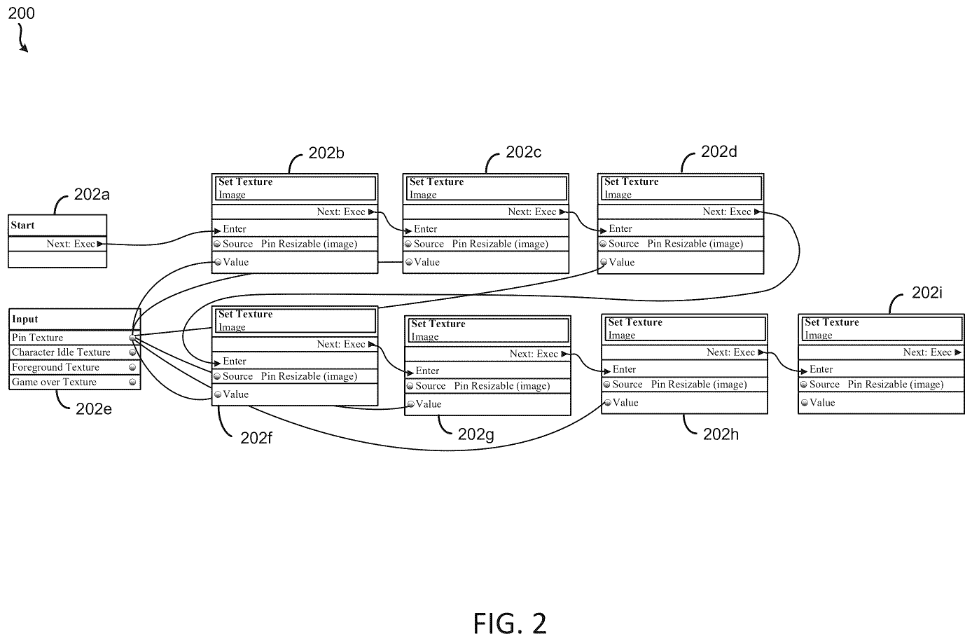

As described above, the service 118 and/or the application 106 can be configured to facilitate visual programming, material editing, and/or particle editing using graphs. A user can use the service 118 and/or the application 106 to create visual, drag-and-drop graphs. Each graph can include a plurality of data nodes configured to process data. The plurality of data nodes can be connected to each other via a plurality of edges (e.g., curves, lines, etc.). However, as shown in the example graph 200 of FIG. 2, it can be difficult to read such graphs as the quantity of data nodes 202a-i and edges (e.g., connections between the data nodes) in the graphs increases. For example, the edges connected the data nodes can cross over each other (e.g., overlap), or portions of some of the edges can disappear behind one or more data nodes.

To improve the readability of such graphs, the service 118 and/or the application 106 can create a new type of connection node applicable to the graphs. The type of connection node can be configured to transmit data, but not to process data. That is, the type of connection does not actually participate in analysis when the graph is parsed. As will be described in more detail below, the type of connection node can be configured to switch positions of input and output ports, which eliminates the need for edges to overlap or disappear behind one or more nodes in the graph. The service 118 and/or the application 106 can implement user-made adjustments to the graphs utilizing the new type of connection node. The service 118 and/or the application 106 can display adjusted graphs that presents logic relationships of the data nodes in a readable and accurate manner.

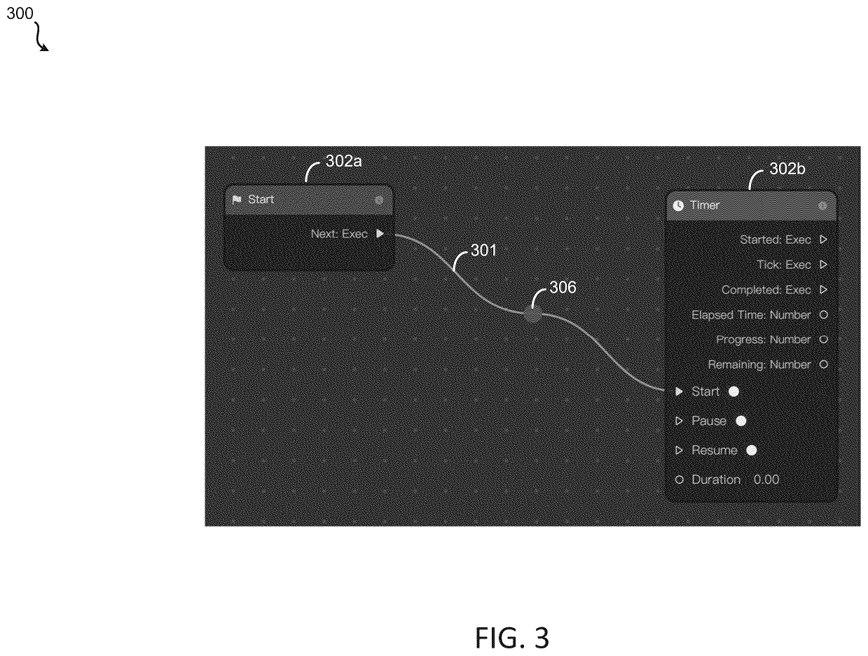

The service 118 and/or the application 106 can cause to present user interfaces (UIs), such as those described below with regard to FIGS. 3-8, via the client devices 104. The UIs can be configured to implement visual scripting using the new type of connection node. As shown in the example graph 300 of FIG. 3, in response to receiving user input, a connection node 306 of the new type can be added to the graph 300. The user input can include a click (e.g., left-click, right-click, etc.) on an edge 301 that connects a data node 302a to a data node 302b in the graph 300. The service 118 and/or the application 106 can add the connection node 306 into the graph 300 in response to receiving the user input. For example, the service 118 and/or the application 106 can add the connection node 306 on the edge 301 that the user clicked on.

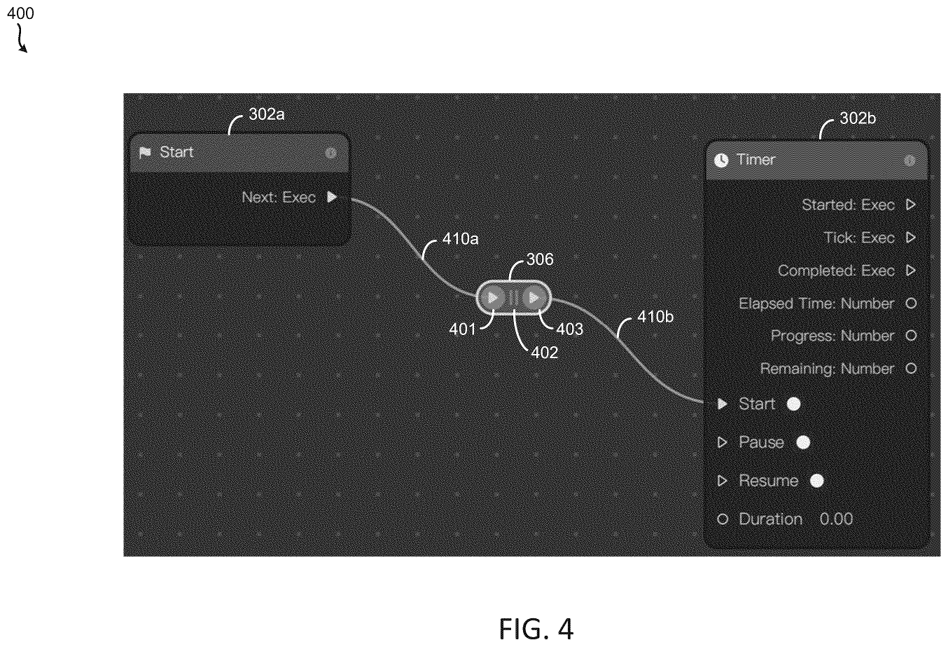

The user can cause adjustments to be made to the graph by interacting with the connection node of the new type that has been added to the graph. As shown in the example graph 400 of FIG. 4, the service 118 and/or the application 106 can cause an expanded state of the connection node 306 to be displayed in response to the user hovering over or clicking on the connection node 306. The expanded state of the connection node 306 can include a first port 401, a second port 403, and a middle area 402 located between the first port 401 and the second port 403. The first port 401 can be connected to a first curve 410a (e.g., first portion of the edge 301). The second port 403 can be connected to a second curve 410b (e.g., second portion of the edge 301). The service 118 and/or the application 106 can change the shape of the edge 301 (e.g., can move the connection node 306 together with the first curve 410a and the second curve 410b) in response to user input on the middle area 402. For example, the service 118 and/or the application 106 can change the shape of the edge 301 in response to the user clicking on and dragging the middle area 402. As another example, the service 118 and/or the application 106 can disconnect the first curve 410a from the connection node 306 in response to receiving user input on the first port 401. Similarly, the service 118 and/or the application 106 can disconnect the second curve 410b from the connection node 306 in response to receiving user input on the second port 403.

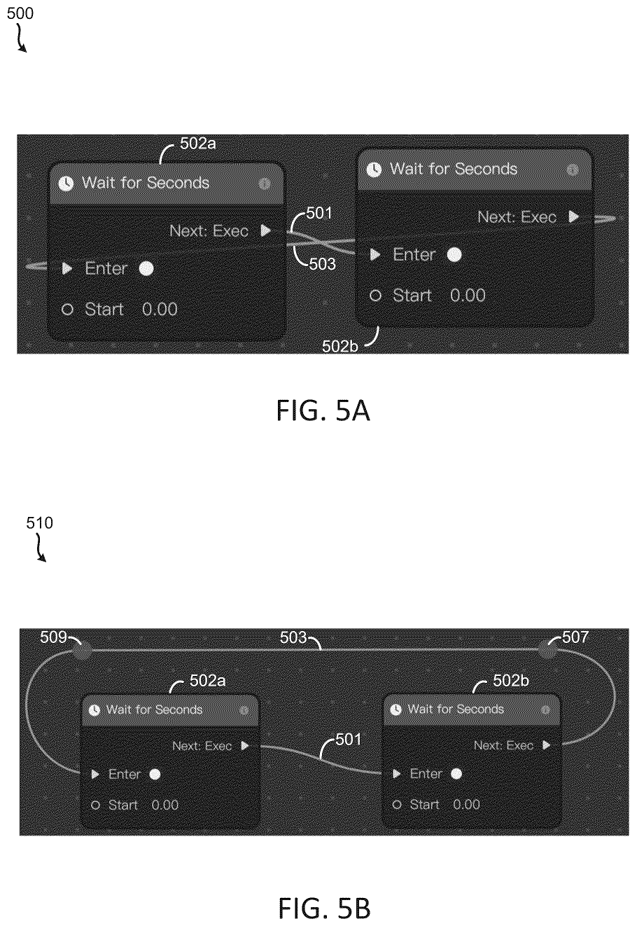

As described above, it can be difficult to read a graph if one or more edges in the graph overlap and/or if portions of the edges disappear behind one or more data nodes. As shown in the example graph 500 of FIG. 5A, a data node 502a is connected to a data node 502b using two edges: edge 501 and edge 503. However, edge 501 and edge 503 cross over each other (e.g., overlap) and a large portion of the edge 503 disappears behind the data node 502a and the data node 502b, making it difficult for a user to understand the logic relationship between the data node 502a and the data node 502b. The new type of connection node described herein can be utilized to eliminate these readability issues.

As shown in the example graph 510 of FIG. 5B, the edges crossing each other can be changed to smooth edges without the crossing by utilizing at least one connection node of the new type. At least one connection node of the new type (e.g., connection nodes 507 and 509) can be added to one of the edges crossing each other (e.g., the edge 503). The user can click and drag the at least one connection node (e.g., connection node 507) to change the shape of the edge 503 such that the edge 503 is no longer crossing the edge 501. Similarly, the user can click and drag the connection node 509 to change the shape of the edge 503 such that the edge 503 is no longer crossing the edge 501. Additionally, or alternatively, after the at least one connection node is added to the edge 503, the user can change a position of the data node 502a and/or the data node 502b to change the shape of the edge 503 such that the edge 503 is no longer crossing the edge 501. The service 118 and/or the application 106 can monitor the status of the curves connected to the at least one connection node and implement the smooth edges based on switching positions of input and output ports of the at least one connection node.

The new type of connection node can be configured to be compatible with different existing data types in the graphs, such as a first data type and a second data type. The first data type can include number data, string data, balloon data, or texture data. The second data type can include a control data type. If the new type of connection node is attached to the first data type, the connection node attached to the first data type can be displayed in a first display mode (e.g., a default mode). The first mode can include a default display mode that is adopted when the connection node is attached to the first data type and when the connection node is not yet attached to any data type. Conversely, if the new type of connection node is attached to the second data type, the connection node attached to the second data type can be displayed in a second display mode. The first display mode can be visually differentiated from the second display mode, such as using color or any other visual indicator. The first display mode can be associated with a first color, such as grey. Displaying the connection node in the first display mode can include displaying the connection node (and all connected edges) in the first color. The second display mode can be associated with a second color, such as green. Displaying the connection node in the second display mode can include displaying the connection node (and all connected edges) in the second color.

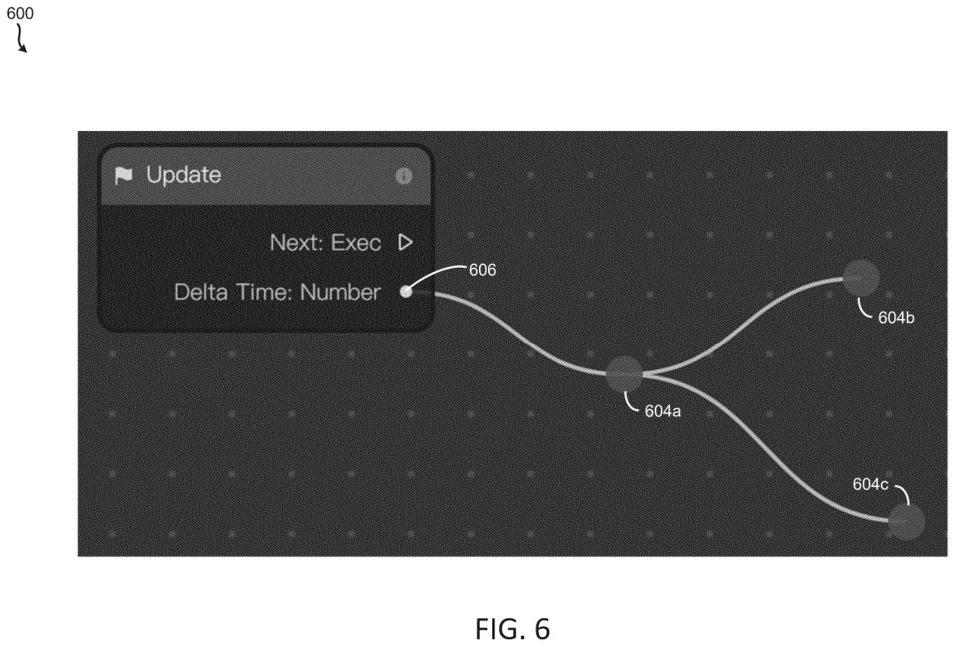

A user can create a group of connection nodes and add the group of connection nodes to a graph. FIG. 6 shows an example graph 600 to which a group of connection nodes 604a-c are added. As shown in FIG. 6, if one of the connection nodes of the group (e.g., connection node 604a) is attached to the first data type 606, the service 118 and/or the application 106 can cause to display the entire group of connection nodes 604a-c in the first display mode. Displaying the entire group of connection nodes 604a-c in the first display mode can include displaying all the connection nodes 604a-c (and all attached edges) in the first color.

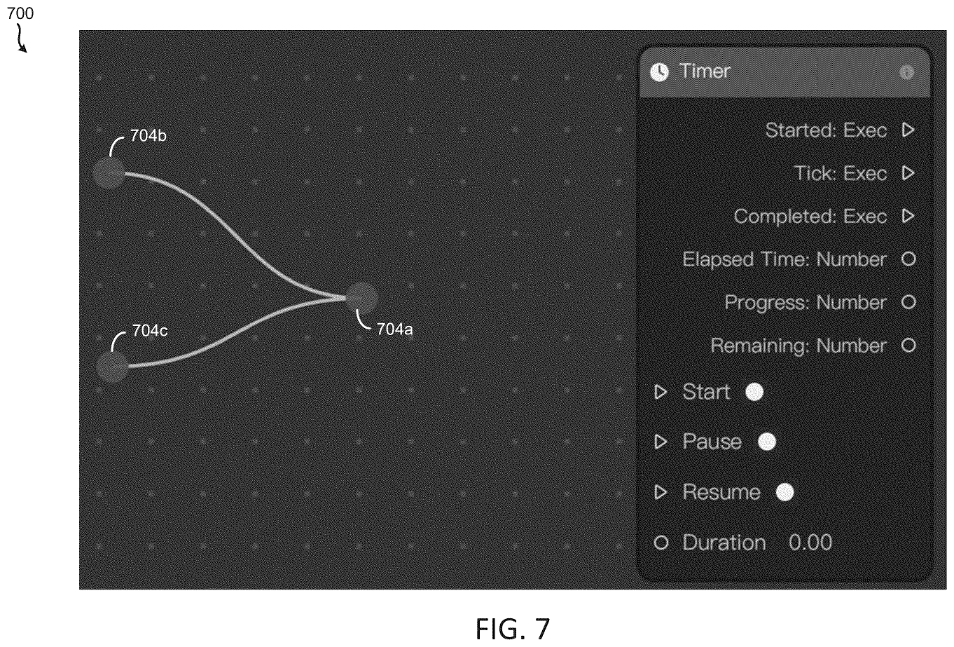

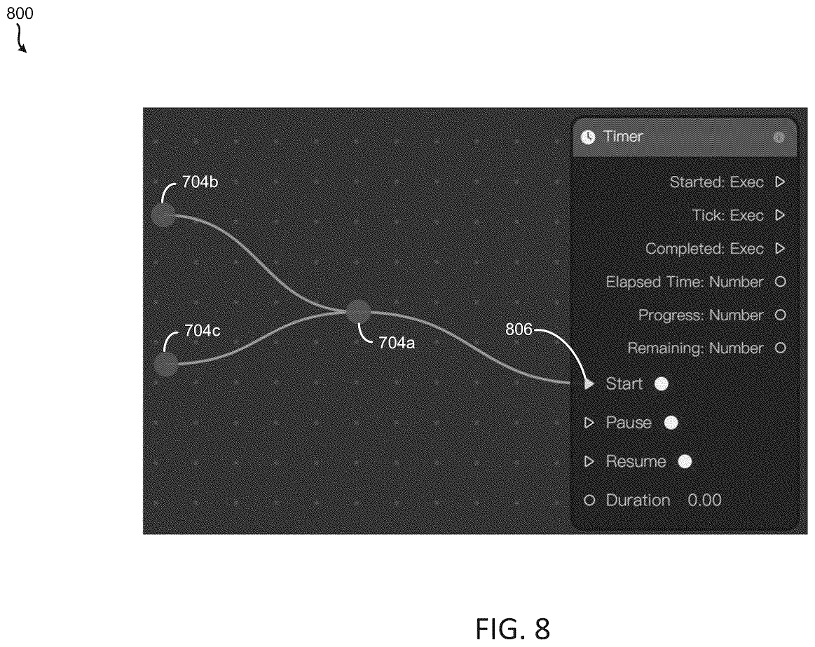

FIG. 7 shows another example graph 700 to which a group of connection nodes (e.g., connection nodes 704a-c) can be created. As shown in FIG. 7, the group of connection nodes (e.g., connection nodes 704a-c) have not yet been connected to any data type. As such, the service 118 and/or the application 106 can display the entire group of connection nodes 6704a-c in the default, first display mode. Displaying the entire group of connection nodes 704a-c in the first display mode can include displaying all the connection nodes 704a-c (and all attached edges) in the first color. As shown in the example graph 800 of FIG. 8, if one of the connection nodes 704a-c, such as the connection node 704a, is connected to the second data type 806, the service 118 and/or the application 106 can cause to display the entire group of connection nodes 704a-c in the second display mode. Displaying the entire group of connection nodes 704a-c in the second display mode can include displaying all the connection nodes 704a-c (and all attached edges) in the second color. If the connection node 704a later is detached from the second data type 806, the service 118 and/or the application 106 can cause to switch back to displaying the group of connection nodes 704a-c in the first display mode.

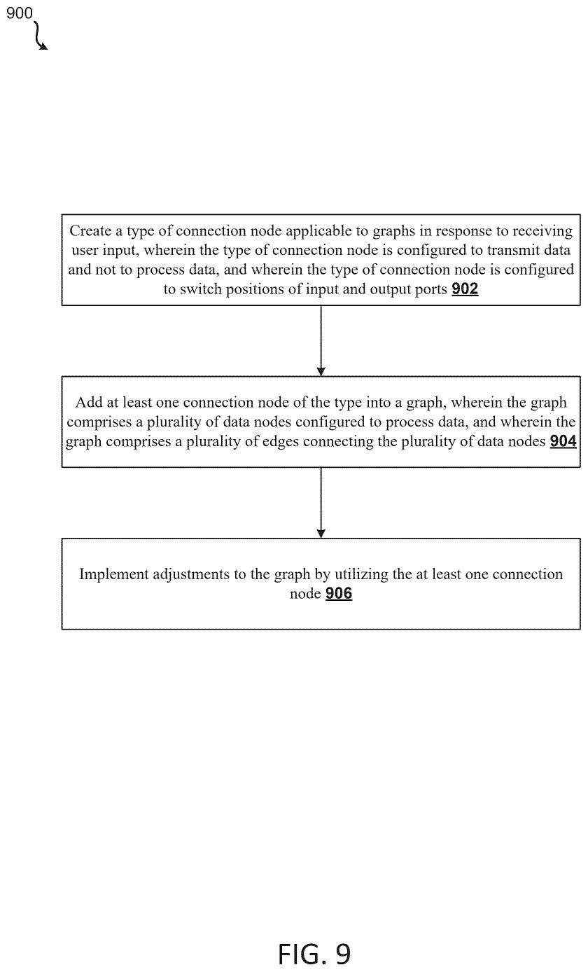

FIG. 9 shows an example process 900 for improving presentation of graphs in accordance with the present disclosure. Although depicted as a sequence of operations in FIG. 9, those of ordinary skill in the art will appreciate that various embodiments can add, remove, reorder, or modify the depicted operations.

To improve the readability of visual graphs, the service 118 and/or the application 106 can create a new type of connection node applicable to the graphs. At 902, the type of connection node can be created. The type of connection node can be created in response to receiving user input. The type of connection node can be configured to transmit data, but not to process data. That is, the type of connection does not actually participate in the visual scripting analysis when the graph is parsed. The type of connection node can be configured to switch positions of input and output ports, which eliminates the need for edges in the graph to overlap or disappear behind one or more data nodes in the graph.

At 904, at least one connection node (e.g., connection node 306) of the type can be added into a graph. The at least one connection node of the type can be added into the graph in response to receiving user input. The graph can include a plurality of data nodes configured to process data. The graph includes a plurality of edges connecting the plurality of data nodes. The user input can include a click (e.g., left-click, right-click, etc.) on an edge (e.g., edge 301) that connects at least two of the data nodes among the plurality of data nodes. At 906, adjustments to the graph can be implemented by utilizing the at least one connection node.

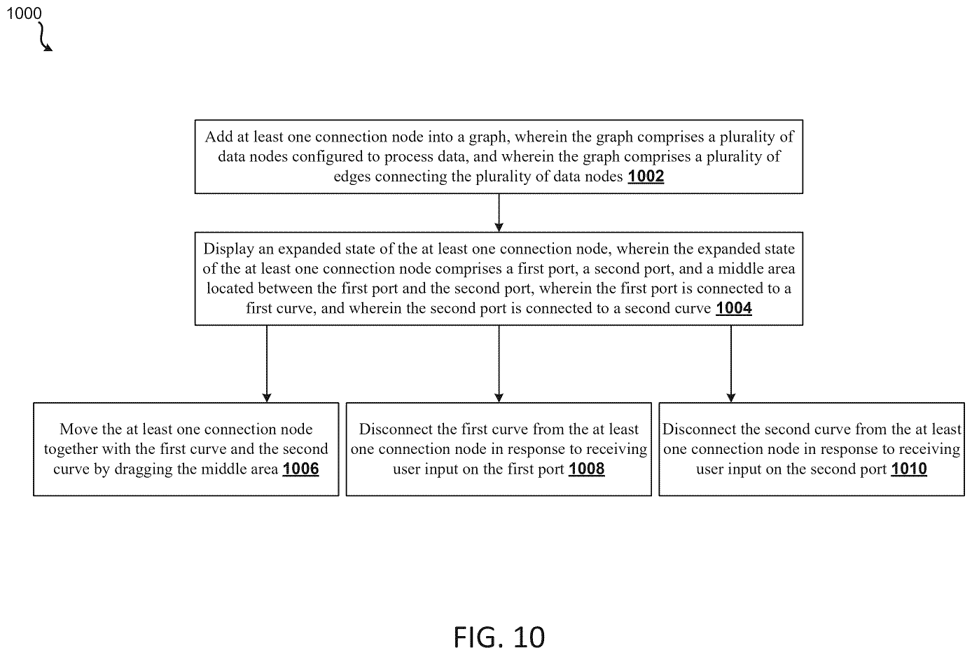

FIG. 10 shows an example process 1000 for improving presentation of graphs in accordance with the present disclosure. Although depicted as a sequence of operations in FIG. 10, those of ordinary skill in the art will appreciate that various embodiments can add, remove, reorder, or modify the depicted operations.

At 1002, at least one connection node (e.g., connection node 306) can be added into a graph in response to receiving user input. The graph can include a plurality of data nodes configured to process data. The graph includes a plurality of edges connecting the plurality of data nodes. The user input can include a click (e.g., left-click, right-click, etc.) on an edge (e.g., edge 301) that connects at least two of the data nodes among the plurality of data nodes.

At 1004, an expanded state of the at least one connection node can be displayed. The expanded state of the at least one connection node can be displayed in response to user input (e.g., in response to a user hovering over or clicking on the at least one connection node). The expanded state of the at least one connection node can include a first port (e.g., first port 401), a second port (e.g., second port 403), and a middle area (e.g., middle area 402) located between the first port and the second port. The first port can be connected to a first curve (e.g., first curve 410a). The second port can be connected to a second curve (e.g., second curve 410b). The method 1000 can proceed to 1006, 1008, and/or 1010.

At 1006, the at least one connection node can be moved, together with the first curve and the second curve, by dragging the middle area. For example, the at least one connection node can be moved, together with the first curve and the second curve in response to a user clicking on and dragging the middle area. At 1008, the first curve can be disconnected from the at least one connection node in response to receiving user input on the first port. At 1010, the second curve can be disconnected from the at least one connection node in response to receiving user input on the second port.

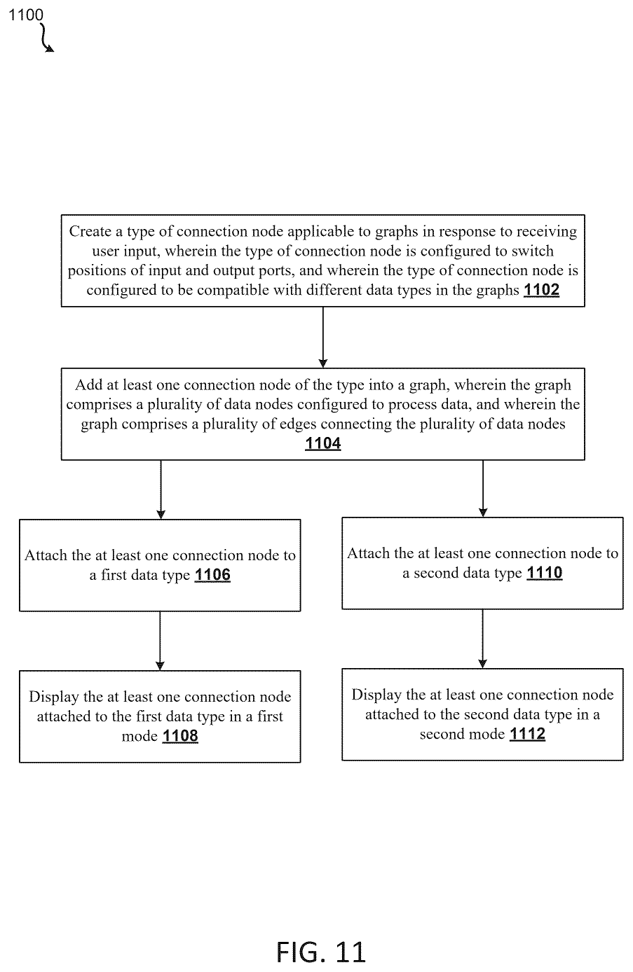

FIG. 11 shows an example process 1100 for improving presentation of graphs in accordance with the present disclosure. Although depicted as a sequence of operations in FIG. 11, those of ordinary skill in the art will appreciate that various embodiments can add, remove, reorder, or modify the depicted operations.

To improve the readability of visual scripting graphs, the service 118 and/or the application 106 can create a new type of connection node applicable to the graphs. At 1102, the type of connection node can be created. The type of connection node can be created in response to receiving user input. The type of connection node can be configured to transmit data, but not to process data. That is, the type of connection does not actually participate in the visual scripting analysis when the graph is parsed. The type of connection node can be configured to switch positions of input and output ports, which eliminates the need for edges in the graph to overlap or disappear behind one or more data nodes in the graph. The type of connection node can be configured to be compatible with different data types in the graphs, including a first data type and a second data type. The first data type can include number data, string data, balloon data, or texture data. The second data type can include a control data type.

At 1104, at least one connection node (e.g., connection node 306) of the type can be added into a graph. The at least one connection node of the type can be added into the graph in response to receiving user input. The graph can include a plurality of data nodes configured to process data. The graph includes a plurality of edges connecting the plurality of data nodes. The user input can include a click (e.g., left-click, right-click, etc.) on an edge (e.g., edge 301) that connects at least two of the data nodes among the plurality of data nodes. The method 1100 can proceed to 1106 or 1110. At 1106, the at least one connection node can be attached to the first data type. At 1108, the at least one connection node attached to the first data type can be displayed in a first mode. The first mode can include a default display mode that is adopted when the connection node is attached to the first data type and when the connection node is not yet attached to any data type. At 1110, the at least one connection node can be attached to the second data type. At 1112, the at least one connection node attached to the second data type can be displayed in a second mode.

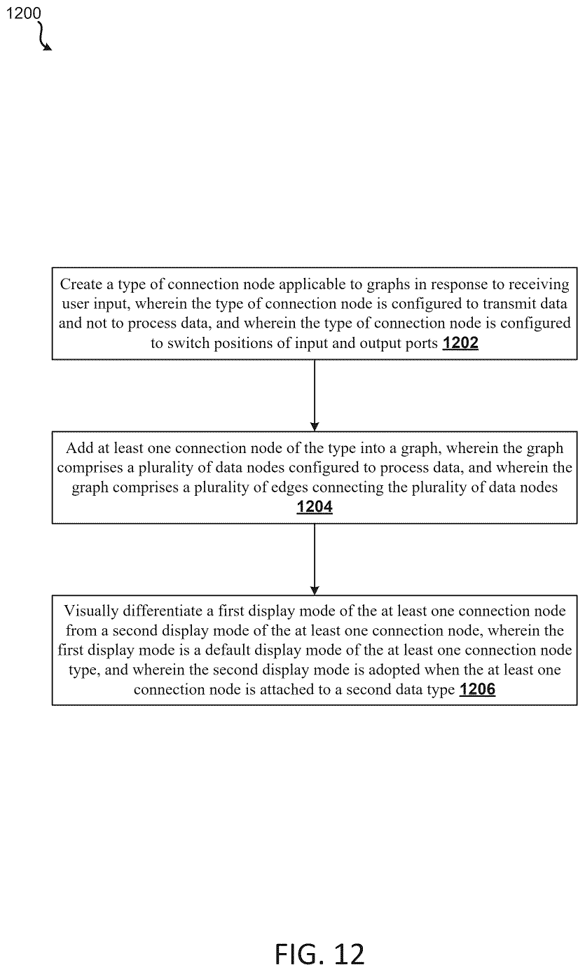

FIG. 12 shows an example process 1200 for improving presentation of graphs in accordance with the present disclosure. Although depicted as a sequence of operations in FIG. 12, those of ordinary skill in the art will appreciate that various embodiments can add, remove, reorder, or modify the depicted operations.

To improve the readability of visual scripting graphs, the service 118 and/or the application 106 can create a new type of connection node applicable to the graphs. At 1202, the type of connection node can be created. The type of connection node can be created in response to receiving user input. The type of connection node can be configured to transmit data, but not to process data. That is, the type of connection does not actually participate in the visual scripting analysis when the graph is parsed. The type of connection node can be configured to switch positions of input and output ports, which eliminates the need for edges in the graph to overlap or disappear behind one or more data nodes in the graph.

At 1204, at least one connection node (e.g., connection node 306) of the type can be added into a graph. The at least one connection node of the type can be added into the graph in response to receiving user input. The graph can include a plurality of data nodes configured to process data. The graph includes a plurality of edges connecting the plurality of data nodes. The user input can include a click (e.g., left-click, right-click, etc.) on an edge (e.g., edge 301) that connects at least two of the data nodes among the plurality of data nodes.

At 1206, a first display mode of the at least one connection node can be visually differentiated from second display mode of the at least one connection node, such as using color or any other visual indicator. The first mode can include a default display mode that is adopted when the at least one connection node is attached to the first data type and when the at least one connection node is not yet attached to any data type. The first display mode can be associated with a first color, such as grey. Displaying the connection node in the first display mode can include displaying the connection node (and all connected edges) in the first color. The second display mode can be adopted when the at least one connection node is attached to a second data type. The second display mode can be associated with a second color, such as green. Displaying the connection node in the second display mode can include displaying the connection node (and all connected edges) in the second color.

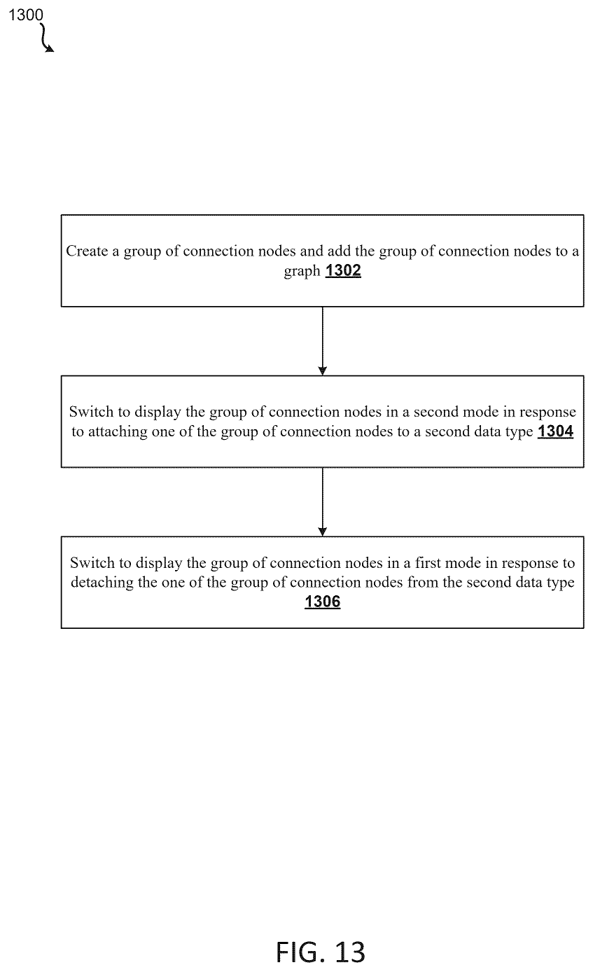

FIG. 13 shows an example process 1300 for improving presentation of graphs in accordance with the present disclosure. Although depicted as a sequence of operations in FIG. 13, those of ordinary skill in the art will appreciate that various embodiments can add, remove, reorder, or modify the depicted operations.

At 1302, a group of connection nodes (e.g., connection nodes 704a-c) can be created and added to a graph. The nodes in the group of connection nodes can be connected via one or more edges. The group of connection nodes can be displayed on the graph in a first (e.g., default) display mode before the group of connection nodes is connected to any data type. At 1304, display of the group of connection nodes can be switched to a second mode in response to attaching one of the group of connection nodes (e.g., node 704a) to a second data type (e.g., second data type 806). At 1306, display of the group of connection nodes can be switched back to the first mode in response to detaching the one of the group of connection nodes from the second data type.

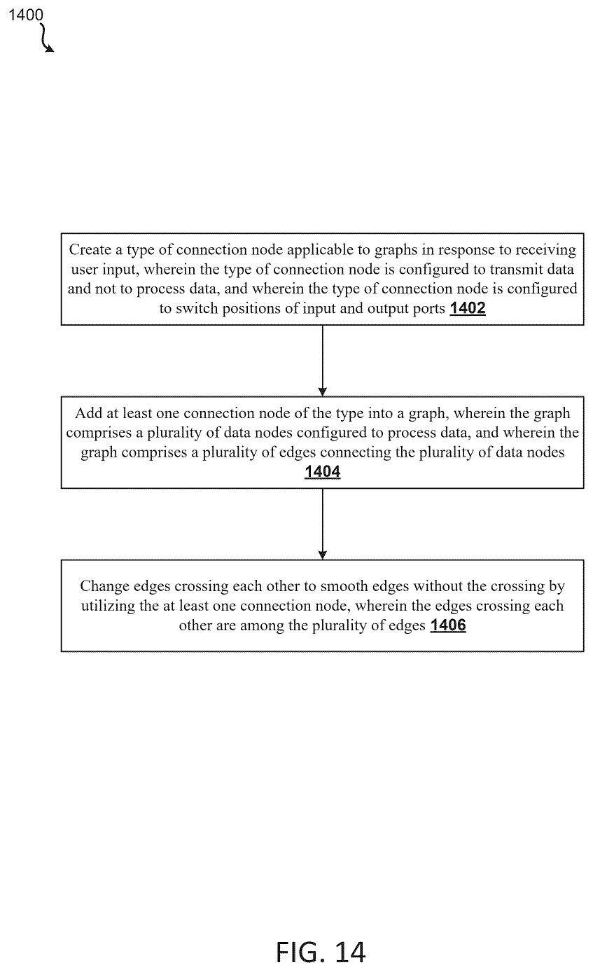

FIG. 14 shows an example process 1400 for improving presentation of graphs in accordance with the present disclosure. Although depicted as a sequence of operations in FIG. 14, those of ordinary skill in the art will appreciate that various embodiments can add, remove, reorder, or modify the depicted operations.

To improve the readability of visual scripting graphs, the service 118 and/or the application 106 can create a new type of connection node applicable to the graphs. At 1402, the type of connection node can be created. The type of connection node can be created in response to receiving user input. The type of connection node can be configured to transmit data, but not to process data. That is, the type of connection does not actually participate in the visual scripting analysis when the graph is parsed. The type of connection node can be configured to switch positions of input and output ports, which eliminates the need for edges in the graph to overlap or disappear behind one or more data nodes in the graph.

At 1404, at least one connection node (e.g., connection node 306) of the type can be added into a graph. The at least one connection node of the type can be added into the graph in response to receiving user input. The graph can include a plurality of data nodes configured to process data. The graph includes a plurality of edges connecting the plurality of data nodes. The user input can include a click (e.g., left-click, right-click, etc.) on an edge (e.g., edge 301) that connects at least two of the data nodes among the plurality of data nodes. It can be difficult to read a graph if one or more edges in the graph cross over each other (e.g., overlap) and/or if portions of the edges disappear behind one or more of the data nodes. At 1406, the edges crossing each other can be changed to smooth edges without the crossing by utilizing the at least one connection node.

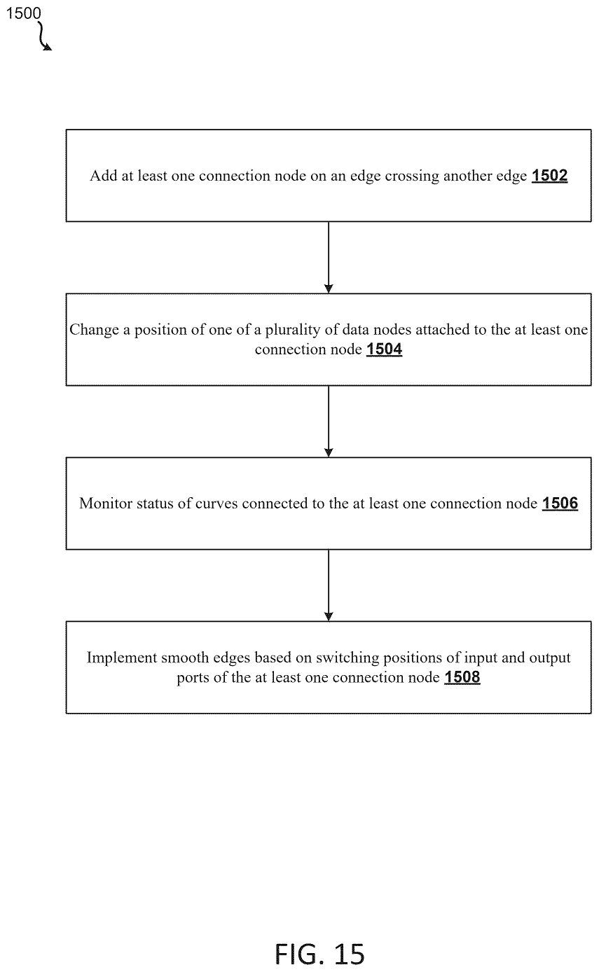

FIG. 15 shows an example process 1500 for improving presentation of graphs in accordance with the present disclosure. Although depicted as a sequence of operations in FIG. 15, those of ordinary skill in the art will appreciate that various embodiments can add, remove, reorder, or modify the depicted operations.

At 1502, at least one connection node (e.g., connection node 507, connection node 509) can be added on an edge (e.g., edge 503) crossing another edge (e.g., edge 501). A user can click and drag the at least one connection node to change the shape of the edge. At 1504, a position of one of a plurality of data nodes attached to the at least one connection node can be changed. For example, the user can change a position of the data node to change the shape of the edge. At 1506, the status of the curves connected to the at least one connection node can be monitored. At 1508, smooth edges can be implemented based on switching positions of input and output ports of the at least one connection node.

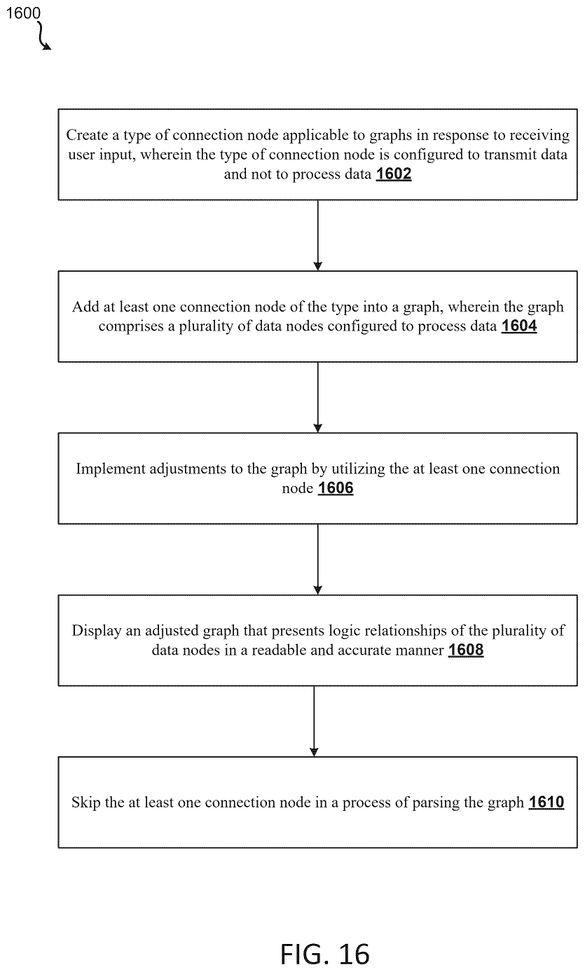

FIG. 16 shows an example process 1600 for improving presentation of graphs in accordance with the present disclosure. Although depicted as a sequence of operations in FIG. 16, those of ordinary skill in the art will appreciate that various embodiments can add, remove, reorder, or modify the depicted operations.

To improve the readability of visual scripting graphs, the service 118 and/or the application 106 can create a new type of connection node applicable to the graphs. At 1602, the type of connection node can be created. The type of connection node can be created in response to receiving user input. The type of connection node can be configured to transmit data, but not to process data. That is, the type of connection does not actually participate in the visual scripting analysis when the graph is parsed. The type of connection node can be configured to switch positions of input and output ports, which eliminates the need for edges in the graph to overlap or disappear behind one or more data nodes in the graph.

At 1604, at least one connection node (e.g., connection node 306) of the type can be added into a graph. The at least one connection node of the type can be added into the graph in response to receiving user input. The graph can include a plurality of data nodes configured to process data. The graph includes a plurality of edges connecting the plurality of data nodes. The user input can include a click (e.g., left-click, right-click, etc.) on an edge (e.g., edge 301) that connects at least two of the data nodes among the plurality of data nodes. At 1606, adjustments to the graph can be implemented by utilizing the at least one connection node. At 1608, an adjusted graph can be displayed. The adjusted graph can present logic relationships of the plurality of data nodes in a readable and accurate manner. At 1610, the at least one connection node can be skipped in a process of parsing the graph.

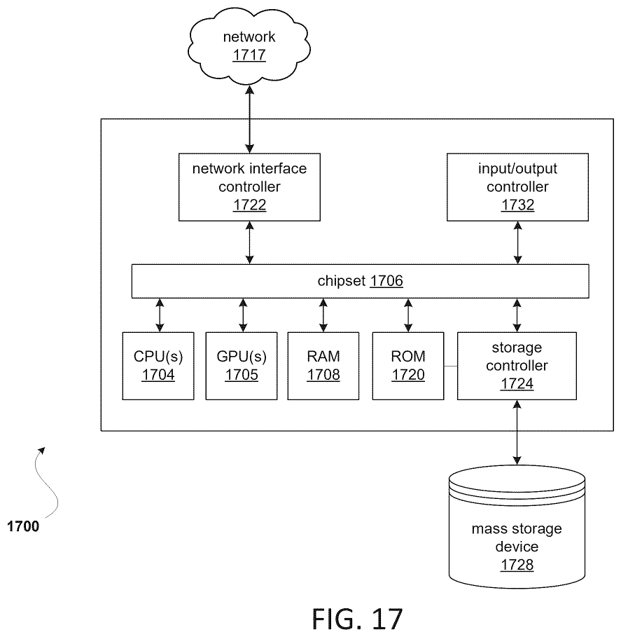

FIG. 17 illustrates a computing device that can be used in various aspects, such as the model(s), components, and/or devices depicted in FIG. 1. With regard to FIG. 1, any or all of the components can each be implemented by one or more instance of a computing device 1700 of FIG. 17. The computer architecture shown in FIG. 17 shows a conventional server computer, workstation, desktop computer, laptop, tablet, network appliance, PDA, e-reader, digital cellular phone, or other computing node, and can be utilized to execute any aspects of the computers described herein, such as to implement the methods described herein.

The computing device 1700 can include a baseboard, or “motherboard,” which is a printed circuit board to which a multitude of components or devices can be connected by way of a system bus or other electrical communication paths. One or more central processing units (CPUs) 1704 can operate in conjunction with a chipset 1706. The CPU(s) 1704 can be standard programmable processors that perform arithmetic and logical operations necessary for the operation of the computing device 1700.

The CPU(s) 1704 can perform the necessary operations by transitioning from one discrete physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits including registers, adders-subtractors, arithmetic logic units, floating-point units, and the like.

The CPU(s) 1704 can be augmented with or replaced by other processing units, such as GPU(s) 1705. The GPU(s) 1705 can comprise processing units specialized for but not necessarily limited to highly parallel computations, such as graphics and other visualization-related processing.

A chipset 1706 can provide an interface between the CPU(s) 1704 and the remainder of the components and devices on the baseboard. The chipset 1706 can provide an interface to a random-access memory (RAM) 1708 used as the main memory in the computing device 1700. The chipset 1706 can further provide an interface to a computer-readable storage medium, such as a read-only memory (ROM) 1720 or non-volatile RAM (NVRAM) (not shown), for storing basic routines that can help to start up the computing device 1700 and to transfer information between the various components and devices. ROM 1720 or NVRAM can also store other software components necessary for the operation of the computing device 1700 in accordance with the aspects described herein.

The computing device 1700 can operate in a networked environment using logical connections to remote computing nodes and computer systems through local area network (LAN). The chipset 1706 can include functionality for providing network connectivity through a network interface controller (NIC) 1722, such as a gigabit Ethernet adapter. A NIC 1722 can be capable of connecting the computing device 1700 to other computing nodes over a network 1718. It should be appreciated that multiple NICs 1722 can be present in the computing device 1700, connecting the computing device to other types of networks and remote computer systems.

The computing device 1700 can be connected to a mass storage device 1728 that provides non-volatile storage for the computer. The mass storage device 1728 can store system programs, application programs, other program modules, and data, which have been described in greater detail herein. The mass storage device 1728 can be connected to the computing device 1700 through a storage controller 1724 connected to the chipset 1706. The mass storage device 1728 can consist of one or more physical storage units. The mass storage device 1728 can comprise a management component 1710. A storage controller 1724 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1700 can store data on the mass storage device 1728 by transforming the physical state of the physical storage units to reflect the information being stored. The specific transformation of a physical state can depend on various factors and on different implementations of this description. Examples of such factors can include, but are not limited to, the technology used to implement the physical storage units and whether the mass storage device 1728 is characterized as primary or secondary storage and the like.

For example, the computing device 1700 can store information to the mass storage device 1728 by issuing instructions through a storage controller 1724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1700 can further read information from the mass storage device 1728 by detecting the physical states or characteristics of one or more particular locations within the physical storage units.

In addition to the mass storage device 1728 described above, the computing device 1700 can have access to other computer-readable storage media to store and retrieve information, such as program modules, data structures, or other data. It should be appreciated by those skilled in the art that computer-readable storage media can be any available media that provides for the storage of non-transitory data and that can be accessed by the computing device 1700.

By way of example and not limitation, computer-readable storage media can include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that can be used to store the desired information in a non-transitory fashion.

A mass storage device, such as the mass storage device 1728 depicted in FIG. 17, can store an operating system utilized to control the operation of the computing device 1700. The operating system can comprise a version of the LINUX operating system. The operating system can comprise a version of the WINDOWS SERVER operating system from the MICROSOFT Corporation. According to further aspects, the operating system can comprise a version of the UNIX operating system. Various mobile phone operating systems, such as IOS and ANDROID, can also be utilized. It should be appreciated that other operating systems can also be utilized. The mass storage device 17228 can store other system or application programs and data utilized by the computing device 1700.

The mass storage device 1728 or other computer-readable storage media can also be encoded with computer-executable instructions, which, when loaded into the computing device 1700, transforms the computing device from a general-purpose computing system into a special-purpose computer capable of implementing the aspects described herein. These computer-executable instructions transform the computing device 1700 by specifying how the CPU(s) 1704 transition between states, as described above. The computing device 1700 can have access to computer-readable storage media storing computer-executable instructions, which, when executed by the computing device 1700, can perform the methods described herein.

A computing device, such as the computing device 1700 depicted in FIG. 17, can also include an input/output controller 1732 for receiving and processing input from a number of input devices, such as a keyboard, a mouse, a touchpad, a touch screen, an electronic stylus, or other type of input device. Similarly, an input/output controller 1732 can provide output to a display, such as a computer monitor, a flat-panel display, a digital projector, a printer, a plotter, or other type of output device. It will be appreciated that the computing device 1700 can not include all of the components shown in FIG. 17, can include other components that are not explicitly shown in FIG. 17, or can utilize an architecture completely different than that shown in FIG. 17.

As described herein, a computing device can be a physical computing device, such as the computing device 1700 of FIG. 17. A computing node can also include a virtual machine host process and one or more virtual machine instances. Computer-executable instructions can be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance can or can not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that can be used to perform the described methods and systems. When combinations, subsets, interactions, groups, etc., of these components are described, it is understood that while specific references to each of the various individual and collective combinations and permutations of these can not be explicitly described, each is specifically contemplated and described herein, for all methods and systems. This applies to all aspects of this application including, but not limited to, operations in described methods. Thus, if there are a variety of additional operations that can be performed it is understood that each of these additional operations can be performed with any specific embodiment or combination of embodiments of the described methods.

The present methods and systems can be understood more readily by reference to the following detailed description of preferred embodiments and the examples included therein and to the Figures and their descriptions.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions can be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions can also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above can be used independently of one another or can be combined in various ways. All possible combinations and sub-combinations are intended to fall within the scope of this disclosure. In addition, certain methods or process blocks can be omitted in some implementations. The methods and processes described herein are also not limited to any particular sequence, and the blocks or states relating thereto can be performed in other sequences that are appropriate. For example, described blocks or states can be performed in an order other than that specifically described, or multiple blocks or states can be combined in a single block or state. The example blocks or states can be performed in serial, in parallel, or in some other manner. Blocks or states can be added to or removed from the described example embodiments. The example systems and components described herein can be configured differently than described. For example, elements can be added to, removed from, or rearranged compared to the described example embodiments.

It will also be appreciated that various items are illustrated as being stored in memory or on storage while being used, and that these items or portions thereof can be transferred between memory and other storage devices for purposes of memory management and data integrity. Alternatively, in other embodiments, some or all of the software modules and/or systems can execute in memory on another device and communicate with the illustrated computing systems via inter-computer communication. Furthermore, in some embodiments, some or all of the systems and/or modules can be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures can also be stored (e.g., as software instructions or structured data) on a computer-readable medium, such as a hard disk, a memory, a network, or a portable media article to be read by an appropriate device or via an appropriate connection. The systems, modules, and data structures can also be transmitted as generated data signals (e.g., as part of a carrier wave or other analog or digital propagated signal) on a variety of computer-readable transmission media, including wireless-based and wired/cable-based media, and can take a variety of forms (e.g., as part of a single or multiplexed analog signal, or as multiple discrete digital packets or frames). Such computer program products can also take other forms in other embodiments. Accordingly, the present invention can be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations can be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of creating graphs, comprising:
creating a type of connection node applicable to the graphs in response to receiving user input, wherein the type of connection node is configured to transmit data and not to process data, and wherein the type of connection node is configured to switch positions of input and output ports;
adding at least one connection node of the type into a graph, wherein the graph comprises a plurality of data nodes configured to process data, and wherein the graph comprises a plurality of edges connecting the plurality of data nodes; and
implementing adjustments to the graph by utilizing the at least one connection node.

2. The method of claim 1, further comprising:
displaying an expanded state of the at least one connection node, wherein the expanded state of the at least one connection node comprises a first port, a second port, and a middle area located between the first port and the second port.

3. The method of claim 2, wherein the first port is connected to a first curve, wherein the second port is connected to a second curve, and wherein the method further comprises:
moving the at least one connection node together with the first curve and the second curve by dragging the middle area;
disconnecting the first curve from the at least one connection node in response to receiving user input on the first port; or
disconnecting the second curve from the at least one connection node in response to receiving user input on the second port.

4. The method of claim 1, wherein the new type of connection node is configured to be compatible with different data types in the graphs.

5. The method of claim 1, further comprising:
attaching the at least one connection node to a first data type; and
displaying the at least one connection node attached to the first data type in a first mode.

6. The method of claim 1, further comprising:
attaching the at least one connection node to a second data type; and
displaying the at least one connection node attached to the second data type in a second mode.

7. The method of claim 1, further comprising:
visually differentiating a first display mode of the at least one connection node from a second display mode of the at least one connection node, wherein the first display mode is a default display mode of the at least one connection node type, and wherein the second display mode is adopted when the at least one connection node is attached to a second data type.

8. The method of claim 7, wherein the default display mode is adopted when the at least one connection node is attached to a first data type, wherein the first data type comprises a number type, a string type, a balloon type, or a texture type, and wherein the second data type comprises a control data type.

9. The method of claim 1, further comprising:
creating a group of connection nodes and adding the group of connection nodes to the graph; and
switching to display the group of connection nodes in a second mode in response to attaching one of the group of connection nodes to a second data type.

10. The method of claim 9, further comprising:
switching to display the group of connection nodes in a first mode in response to detaching the one of the group of connection nodes from the second data type.

11. The method of claim 1, further comprising:
changing edges crossing each other to smooth edges without the crossing by utilizing the at least one connection node, wherein the edges crossing each other are among the plurality of edges.

12. The method of claim 11, wherein the changing edges crossing each other to smooth edges without the crossing by utilizing the at least one connection node further comprises:
adding the at least one connection node on one of the edges crossing each other;
changing a position of one of the plurality of data nodes attached to the at least one connection node;
monitoring status of curves connected to the at least one connection node; and
implementing the smooth edges based on switching positions of input and output ports of the at least one connection node.

13. The method of claim 1, further comprising:
skipping the at least one connection node in a process of parsing the graph.

14. A system of creating graphs, comprising:
at least one processor; and
at least one memory communicatively coupled to the at least one processor and comprising computer-readable instructions that upon execution by the at least one processor cause the at least one processor to perform operations comprising:
creating a type of connection node applicable to the graphs in response to receiving user input, wherein the type of connection node is configured to transmit data and not to process data, and wherein the type of connection node is configured to switch positions of input and output ports;
adding at least one connection node of the type into a graph, wherein the graph comprises a plurality of data nodes configured to process data, and wherein the graph comprises a plurality of edges connecting the plurality of data nodes; and
implementing adjustments to the graph by utilizing the at least one connection node.

15. The system of claim 14, the operations further comprising:
displaying an expanded state of the at least one connection node, wherein the expanded state of the at least one connection node comprises a first port, a second port, and a middle area located between the first port and the second port, wherein the first port is connected to a first curve, and wherein the second port is connected to a second curve.

16. The system of claim 14, the operations further comprising:
visually differentiating a first display mode of the at least one connection node from a second display mode of the at least one connection node, wherein the first display mode is a default display mode of the at least one connection node type, and wherein the second display mode is adopted when the at least one connection node is attached to a second data type.

17. The system of claim 14, the operations further comprising:
changing edges crossing each other to smooth edges without the crossing by utilizing the at least one connection node, wherein the edges crossing each other are among the plurality of edges.

18. A non-transitory computer-readable storage medium, storing computer-readable instructions that upon execution by a processor cause the processor to implement operations comprising:
creating a type of connection node applicable to the graphs in response to receiving user input, wherein the type of connection node is configured to transmit data and not to process data, and wherein the type of connection node is configured to switch positions of input and output ports;
adding at least one connection node of the type into a graph, wherein the graph comprises a plurality of data nodes configured to process data, and wherein the graph comprises a plurality of edges connecting the plurality of data nodes; and
implementing adjustments to the graph by utilizing the at least one connection node.

19. The non-transitory computer-readable storage medium of claim 18, the operations further comprising:
displaying an expanded state of the at least one connection node, wherein the expanded state of the at least one connection node comprises a first port, a second port, and a middle area located between the first port and the second port, wherein the first port is connected to a first curve, and wherein the second port is connected to a second curve.

20. The non-transitory computer-readable storage medium of claim 18, the operations further comprising:
changing edges crossing each other to smooth edges without the crossing by utilizing the at least one connection node, wherein the edges crossing each other are among the plurality of edges.
